(19) United States
(12) Patent Application Publication
(10) Pub. No.: US 2024/0143707 A1
(43) Pub. Date: May 2, 2024

(54) REMOTE AUTHORISATION

(71) Applicant: ONEPLAN UNDERWRITING MANAGERS (PTY) LTD, Johannesburg (ZA)

(72) Inventors: Michael Robert Otten, Johannesburg (ZA); Nicole Roseline Dessington, Johannesburg (ZA)

(21) Appl. No.: 18/548,131

(22) PCT Filed: Feb. 28, 2022
(86) PCT No.: PCT/IB2022/051749

§ 371 Date: Aug. 28, 2023

(30) Foreign Application Priority Data
Mar. 1, 2021 (ZA) 2021/01384

(51) Int. Cl. G06F 21/30; G06Q 40/08

(52) U.S. Cl. CPC G06F 21/305; G06Q 40/08

(57) ABSTRACT

A remote authorisation system and method is provided. A method includes receiving, from a remote computing device, a claim request message including a set of event data elements relating to an event and a client profile identifier. The method includes initiating initial processing of a claim associated with the event including: using the event data elements to determine a category indicator with which the event is associated; and, if the event is associated with a first category indicator, provisionally authorising the claim and transmitting a provisional authorisation confirmation message to one or both of the remote computing device and a client communication device for initiating emergent mitigation of a condition or consequence associated with the event

### CROSS-REFERENCE TO RELATED APPLICATIONS

This application claims priority from South African provisional patent application number 2021/01384 filed on 1 Mar. 2021, which is incorporated by reference herein.

### FIELD OF THE TECHNOLOGY

This technology relates to remote authorisation, in particular, but not limited to, the remote authorisation of a claim associated with an event.

### BACKGROUND

In the context of insurance, and health-related (including animal health-related) insurance in particular, different claims relating to different events can trigger different liabilities for an insurance provider underwriting the claims. In health-related insurance, the different liabilities typically depend on whether or not treatment associated with the event requires hospitalisation (or generally, an “admission”). Further, some types of events, such as life-threating accidents, require urgent treatment (for example, within two hours), which in turn requires authorisation of a claim associated with such an event to be as close as possible to real-time so as to minimise delays in treatment and hence improve treatment outcomes.

The preceding discussion of the background to the invention is intended only to facilitate an understanding of the present technology. It should be appreciated that the discussion is not an acknowledgment or admission that any of the material referred to was part of the common general knowledge in the art as at the priority date of the application.

### SUMMARY

In accordance with an aspect of the invention there is provided a computer-implemented method for remote authorisation comprising: receiving, from a remote computing device, a claim request message including a set of event data elements relating to an event and a client profile identifier; initiating initial processing of a claim associated with the event including: using the event data elements to determine a category indicator with which the event is associated; and, if the event is associated with a first category indicator, provisionally authorising the claim and transmitting a provisional authorisation confirmation message to one or both of the remote computing device and a client communication device for initiating emergent mitigation of a condition or consequence associated with the event.

The event data elements may include data elements relating to one or more of: hospitalisation; procedure; drip setup; surgery; sedition; anaesthesia; severity; treatment plan; duration of admittance; duration of procedure.

Provisionally authorising the claim if the event is associated with a first category indicator may include providing access to funds. Providing access to funds may include transferring funds to an account associated with a portable payment device linked to the client profile identifier.

The event data elements may include the category indicator, and using the event data elements to determine the category indicator may include extracting the category indicator from the event data elements.

The method may include retrieving profile information associated with the client profile identifier. The profile information may include exclusion data and the method may include: determining if the claim is excluded based on one or both of the exclusion data and event data elements; and, if the claim is not excluded, initiating the initial processing of the claim.

The method may include determining authorisation of the claim. Determining authorisation of the claim may include: providing the event data elements for assessment; processing the event data elements to determine a set of assessment data elements relating to assessment of the event and including an authorisation cover type indicator; and, receiving the assessment data elements and authorising the claim based on the authorisation cover type indicator.

The method may include updating a reference database, including storing the event data elements together with one or more of event, category and authorisation cover type indicator labels.

Processing the event data elements to determine the set of assessment data elements may include using an algorithm having been trained using training data available from the reference database. Processing the event data elements may include using an admission matrix and/or profile information associated with the client profile identifier and retrieved from the profile database.

In accordance with a further aspect of the invention there is provided a system for remote authorisation including a memory for storing computer-readable program code and a processor for executing the computer-readable program code, the system comprising: a claim request message receiving component for receiving, from a remote computing device, a claim request message including a set of event data elements relating to an event and a client profile identifier;

an initiation component for initiating initial processing of a claim associated with the event including: a category indicator determining component for using the event data elements to determine a category indicator with which the event is associated; and, a provisional authorisation component for, if the event is associated with a first category indicator, provisionally authorising the claim and transmitting a provisional authorisation confirmation message to one or both of the remote computing device and a client communication device for initiating emergent mitigation of a condition or consequence associated with the event.

The event data elements may include data elements relating to one or more of: hospitalisation; procedure; drip setup; surgery; sedition; anaesthesia; severity; treatment plan; duration of admittance; duration of procedure.

The provisional authorisation component may include a funding component for providing access to funds. The funding component may be configured to transfer funds to an account associated with a portable payment device linked to the client profile identifier.

The event data elements may include the category indicator and the category indicator determining component may include a category indicator extractor component configured to extract the category indicator from the event data elements.

The system may include a profile information retrieving component for retrieving profile information associated with the client profile identifier. The profile information may include exclusion data and the system may include an exclusion data processing component for processing the event data elements against the exclusion data to determine if the claim is excluded based on the exclusion data and/or event data elements.

The system may include an authorisation determining component for determining authorisation of the claim. The authorisation determining component may include: an event data elements providing component for providing the event data elements for assessment; an event data elements processing component for processing the event data elements to determine a set of assessment data elements relating to assessment of the event and including an authorisation cover type indicator; an assessment data elements receiving component for receiving the assessment data elements and authorising the claim based on the authorisation cover type indicator.

In accordance with a further aspect of the invention there is provided a computer program product for remote authorisation, the computer program product comprising a computer-readable medium having stored computer-readable program code for performing the steps of: receiving, from a remote computing device, a claim request message including a set of event data elements relating to an event and a client profile identifier: initiating initial processing of a claim associated with the event including: using the event data elements to determine a category indicator with which the event is associated; and, if the event is associated with a first category indicator, provisionally authorising the claim and transmitting a provisional authorisation confirmation message to one or both of the remote computing device and a client communication device for initiating emergent mitigation of a condition or consequence associated with the event.

Further features provide for the computer-readable medium to be a non-transitory computer-readable medium and for the computer-readable program code to be executable by a processing circuit.

Embodiments of the technology will now be described, by way of example only, with reference to the accompanying drawings.

### BRIEF DESCRIPTION OF THE DRAWINGS

In the drawings:

FIG. 1 is a schematic diagram which illustrates an example embodiment of a system for remote authorisation according to aspects of the present disclosure;

FIG. 2 is a flow diagram which illustrates an example embodiment of a method for remote authorisation according to aspects of the present disclosure;

FIG. 3 illustrates an example embodiment of a claim request message according to aspects of the present disclosure;

FIG. 4 illustrates an example embodiment of event data elements according to aspects of the present disclosure;

FIG. 5 is a flow diagram which illustrates example operations related to receiving a claim request message according to aspects of the present disclosure;

FIG. 6 is a flow diagram which illustrates example operations related to processing a claim request according to aspects of the present disclosure;

FIG. 7 is a flow diagram which illustrates an example embodiment of an admission matrix according to aspects of the present disclosure;

FIG. 8 is a block diagram which illustrates exemplary components which may be provided by a system for remote authorisation according to aspects of the present disclosure; and,

FIG. 9 illustrates an example of a computing device in which various aspects of the disclosure may be implemented.

### DETAILED DESCRIPTION WITH REFERENCE TO THE DRAWINGS

A system and method for remote authorization are provided herein. Aspects of the present disclosure relate to a remote authorisation system and method using an “admission matrix”, or assessment model, and “triage”, or categorisation, according to which the severity of an event (e.g. an injury) can be determined and/or whether or not such an event should result in an admission. An admission triggers a certain benefit in an insurance product (and hence incurs an increased cost of claim for the insurance provider). The admission matrix described herein is configured for use in establishing an authorisation (or approval) cover type indicator (e.g. consultation/illness/accident) associated with the event and stipulating the type of cover under which treatment of the event will be covered (if any). Aspects of the present disclosure enable near real-time provisional authorisation of claims associated with time-critical events based on category indicator. This may enable emergent mitigation of conditions or consequences associated with the event (including for example treatment of a condition associated with or arising from the event).

In the system and method described herein, a claim request message at least including data elements relating to an event in respect of which the claim relates, and optionally including a category indicator and claim cover type indicator, is received. The event data elements describe the event and the category indicator (if any) describes the severity of the event. The claim cover type indicator (if any) indicates the type of cover under which the claim in respect of the event is requested to be covered. Types of cover may include: consultation cover; illness cover; and accident cover, each of which may be associated with different limits and different exclusions (including waiting periods). The system and method described herein may use (or determine and then use) the category indicator and event data elements to determine an authorisation cover type indicator, being the type of cover under which the claim in respect of the event is authorised or approved for cover based on the category indicator and event data elements. Determining the authorisation cover type indicator may include using an admission matrix.

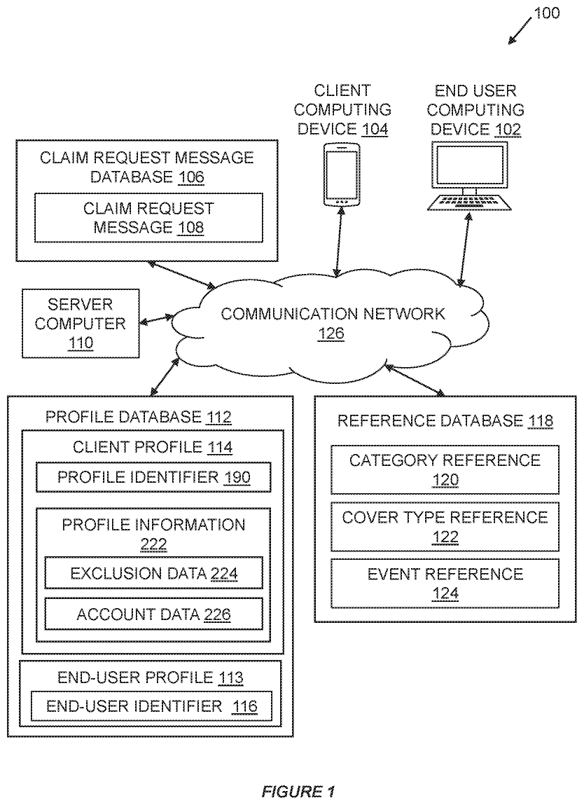

FIG. 1 illustrates an example embodiment of a system (100) for remote authorisation. The system (100) may include a server computer (110) in communication with one or more end-user computing devices (102) via a suitable communication network (126), such as the Internet, via which information and/or data can be communicated between the server computer (110) and end-user computing devices (102). The end-user computing devices (102) may be provided remotely from the server computer (110) and may thus be termed “remote computing devices (102).” The system (100) may also include one or more client communication devices (104). Each client communication device may be in communication with the server computer (110) via the communication network (126).

The server computer (110) may be any suitable computing device configured to perform a server role. The server computer (110) may be maintained by an insurance provider or a third party providing a service to an insurance provider. The physical location of the server computer (110) may be irrelevant and unknown to end-users making use of the system (100).

The server computer (110) has access to and/or maintains a profile database (112). The profile database (112) may store an end-user profile (113) associated with a corresponding an end-user identifier (116) for each end-user (e.g. for each care facility).

The end-user profile (113) may store data relating to the end-user, such Know-Your-Customer (KYC) Information, account information and the like. The end-user identifier (116) may be any parameter used to uniquely identify the end-user, such as a string, QR code, barcode, link (or part thereof), GUID (Globally Unique Identifier, such as 8B60B3E0-0286-49FC-AEFD-E05ABB83FC3F) or the like.

Each new end-user may be registered on the system as a vendor and allocated an end-user identifier. After the end-user is vetted, an account associated with the end-user is activated which allows payments to be processed against the account. Each end-user may be provided a web link via which the server computer is remotely accessible by the end-user computing device (102). The end-user identifier may be embedded into the web link (e.g. through a request query parameter/variable). This request query parameter/variable enables tracking of claims created by the end-user. In some embodiments, upon creating a claim, additional machine specific details are also recorded against the claim, which may be used for validation of the claim and/or end-user identifier associated with the claim.

The profile database (112) may store a client profile (114) for each insured party. Each client profile is associated with a client profile identifier (190) and stores information relating to the client, such as KYC information, and any dependents (or insured items, animals, etc.). The client profile (114) may store or be associated with profile information (222) for each dependent including one or more of: a profile or insurance plan type; types of cover for which the client is insured; exclusion data (224): account data (226): historic claims data; limit data and the like. Exclusion data (224) and/or limit data may be associated with a type of cover. For example, an insurance product may include cover for one or more of the following types of cover: ‘accident’; ‘illness;’ and, ‘consultation’ (e.g. vet visit). Accident and consultation cover types may have no exclusions (but may be subject to limits). Illness types may be associated with exclusion data (224) including, for example: exclusion for pre-existing conditions for a predetermined period (e.g. 12 months) and waiting periods (for example a general three month waiting period for all illness claims and a twelve month waiting period for predefined conditions). Predefined conditions may for example relate to one or more of: Endocrine system; Digestive or urinary tract related illness; Cancer; Arthritis; Heart disease; Skin conditions for e.g. manage, hot spots etc.; Tumours/masses/growths; Eye conditions: Back/spinal conditions: Hip/femoral head, knee, elbow, shoulder and/or ligament conditions (excluding cruciate ligament, limited to one per pet per year); IMHA (Immune-Mediated Hemolytic anemia), Tuberculosis (TB): Congenital, hereditary and pre-existing conditions.

The server computer (110) may also have access to and/or maintain a claim request message database (106). The claim request message database (106) may store received claim request messages (or copies thereof), event data elements extracted therefrom and the like. An example claim request message is later described in greater detail with reference to FIG. 3.

The server computer (110) may also have access to and/or maintain a reference database (118). The reference database (118) may store event data element references and/or one or more of a category reference (120), cover type reference (122), event reference (124) or the like, which may be used for identifying or determining the category, cover type and event associated with an incoming claim request message. The reference database may be built up over time. Initially, the reference data stored in the reference database may be manually labelled by claims assessors as to category, cover type, event and the like. The reference database may serve as a training data repository for training the determining and processing algorithms described herein.

Each end-user computing device (102) may be provided by any suitable computing device, such as a laptop, desktop, mobile device (mobile phone, tablet computer, personal digital assistant, etc), wearable computing device, point of sales device or the like. Each end-user computing device (102) may be located at a care facility (e.g. a vet facility, veterinary practice, health facility, hospital, clinic etc.) at which an action (e.g. treatment) in respect of an event (e.g. accident or illness or other condition) is to be conducted.

Each client communication device (104) may be provided by a suitable computing device with a communication functionality, such as a laptop, desktop, mobile device, wearable computing device or the like. Each client communication device may have a software application resident therein and installed thereon. The software application may be provided for download from a third party software application repository by the insurance provider or the third party service provider, as the case may be. Each client communication device is associated with a client of the insurance provider having an insurance plan (e.g. Accident Plan, Hospital Plan, Classic Plan, Super Plan, etc.).

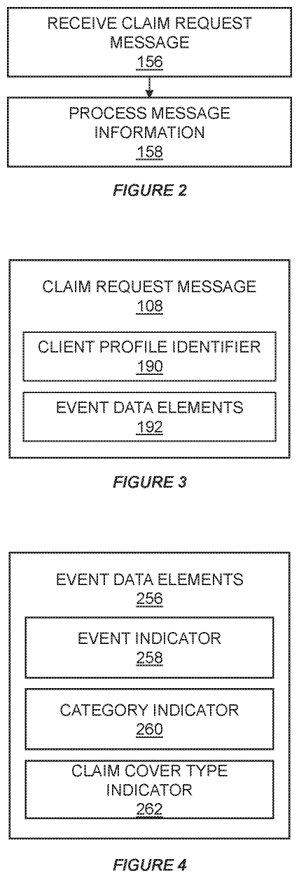

The system (100) described above may implement a method for remote authorisation. An example embodiment of a method for remote authorisation is described in greater detail below with reference to FIGS. 2 to 7.

The method may be conducted by a computing device, such as the server computer (110). The method includes receiving (156) a claim request message (108) from an end-user computing device (102) and processing (158) information associated with the claim request message (108).

An example claim request message (108), referring now to FIG. 3, includes a client profile identifier (190) and event data elements (192). The client profile identifier (190) uniquely identifies a client profile (114) and may be any parameter used to uniquely identify a client profile (114) such as a string (or part thereof), QR code, barcode, link, GUID or the like. The event data elements (192), referring now to FIG. 4, may include data elements relating to one or more of: hospitalisation; procedure; drip setup; surgery; sedition; anaesthesia; severity; treatment plan; duration of admittance; duration of procedure, and the like. In some embodiments, event data elements (192) may include an event indicator (258) identifying the event that is proposed to be claimed (e.g. ‘a bee sting’), a claim cover type indicator (e.g. being the type of cover under which the claim is made, such as ‘illness’, ‘accident’ or ‘consultation’) (262) indicating the type of cover under which the claim is made; and a category indicator (e.g. ‘red’, ‘yellow’ or ‘green’ severity) (260) indicating the category of severity in which the event is classified.

The severity may be a triage-based categorisation of the severity of the event. An example triage-based categorisation may be as follows:
Green: A non-critical, non-life-threatening event that can be treated after 48 hours after illness or injury manifested;
Yellow: A life-threatening event that may have long term/permanent damage if not treated within 2-48 hours; and,
Red: A life-threatening event that requires immediate treatment within 2 hours.

Typically, an event associated with a green triage is covered under a consultation (vet visit) for comprehensive plans. No cover will be provided for hospital plans. An event associated with a yellow triage will be considered under either consultation or hospital cover and assessed together with the admission matrix (if not related to a pre-existing condition or an exclusion). An event associated with red triage will typically be covered under applicable hospital cover (if not related to a pre-existing condition or an exclusion).

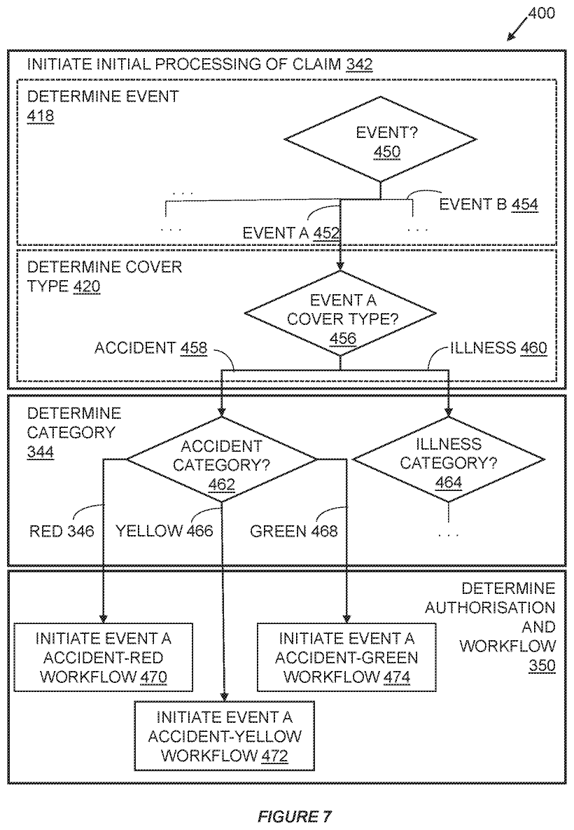

The event indicator (258), claim cover type indicator (262), category indicator (260) and the like may be explicitly expressed in the claim request message (108) or inferred through processing from the content of the claim request message, as determined by a determination method. Example determination methods are later described in greater detail with reference to FIG. 7.

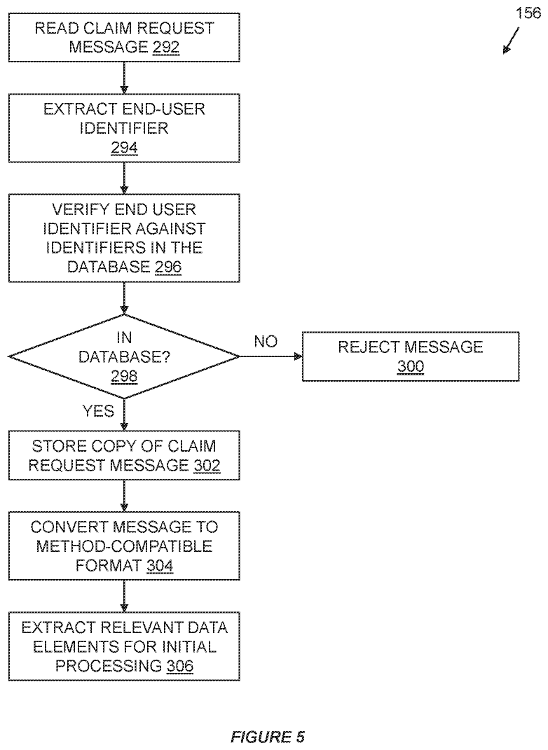

Referring now to FIG. 5, receiving (156) the claim request message (108) may include validating the message, for example including reading (292) the claim request message (108); searching for and, if found, extracting (294) an end-user identifier (116) associated with the claim request message (108); and verifying (296) the end-user identifier (116) against identifiers in the profile database (112). Reading the message may include processing the message using a suitable language algorithm (e.g. a natural language processing, NLP, algorithm or the like) to extract relevant keywords. In one example embodiment, the end-user identifier is embedded into a link (e.g. through a request query parameter/variable) via which the remote computing device connects to the server computer. In some embodiments, receiving the claim request message includes receiving additional machine specific details and validating the message includes validating the additional machine specific details. If (298) the end-user identifier (116) is not found or validated, the claim request message (108) may be rejected (300). If (298) the end-user identifier (116) is validated, the claim request message (108) or a copy thereof may be stored (302) in the claim request message database (106). The claim request message (108) may then be converted (304) to a compatible format and relevant data elements may be extracted (306) for processing (158). Data elements, such as event data elements, may be extracted based on keywords determined by reading the claim request message.

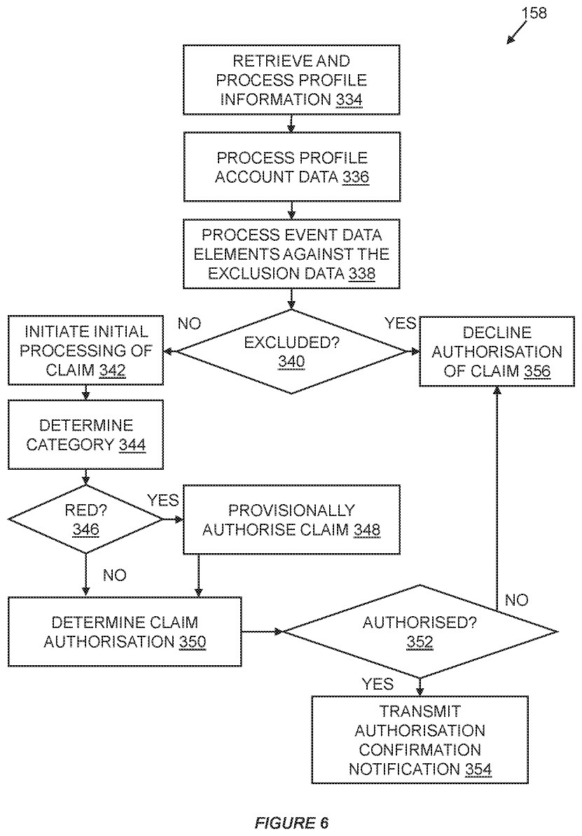

Processing (158) information associated with the claim request message may include, with reference now to FIG. 6, retrieving and processing (334) profile information (222) associated with the profile identifier (190) recorded in the claim request message (108). The profile information (222) may be retrieved from a client profile (114) stored in the profile database (112) in association with the profile identifier (190).

Processing (334) profile information may include processing profile account data, which may for example include determining if a profile account and policy are active, determining the profile plan type, determining the applicable policy schedule for the profile and/or the like.

The profile information (222) may further include exclusion data (224) and the method may include processing (338) the event data elements (192) from the claim request message (108) against the exclusion data (224) to determine if the claim is excluded based on one or more of: the exclusion data (224), the event data elements (192) and a claim cover type indicator (262). Determining if the claim is excluded may include checking applicable waiting periods and checking for excluded illnesses. In some embodiments, only data elements associated with an illness claim cover type indicator (262) are evaluated for exclusion (e.g. because illness cover includes waiting periods for pre-existing conditions or other specified conditions).

If (340) the claim is excluded, the method includes declining (356) authorisation of the claim and a declined claim notification may be transmitted to one or both of the remote computing device (102) and client communication device. If (340) the claim is not excluded, the method may include initiating initial processing (342) of the claim.

Initiating initial processing (342) of the claim associated with the event includes using the event data elements (192) to determine (344) a category indicator (260) with which the event is associated. In some embodiments, the event data elements (192) may include the category indicator (e.g. as a severity data element) (260) and using the event data elements (192) to determine (344) the category indicator (260) may include extracting the category indicator (260) from the event data elements (192). In other embodiments, the method may include processing (338) the event data elements (192) to determine (344) the category indicator.

If the event is associated with a first (e.g. red (346) category indicator (260), the initial processing (342) includes provisionally authorising (348) the claim and transmitting a provisional authorisation confirmation message. The provisional authorisation confirmation message may be transmitted to the remote computing device (102) and/or to the client communication device. Provisionally authorising the claim if the event is associated with a first category indicator (260) may include providing access to funds. Providing access to funds may include transferring or otherwise provisioning funds to an account associated with a portable payment device linked to the profile identifier (e.g. a chip-enabled smart card, such as a ONECARD™, a bank issued credit or debit card, a client communication device configured for contactless payments or the like). The portable payment device may be configured for presentation as payment credential to a care facility (e.g. a vet facility to pay a deposit for the emergency treatment). This may enable treatment of the condition to commence immediately.

The method may include determining authorisation of the claim 350). This may include: providing the event data elements (192) for assessment; processing the event data elements (192) to determine a set of assessment data elements relating to assessment of the event and including an authorisation cover type indicator; and, receiving the assessment data elements and authorising the claim based on the authorisation cover type indicator. The authorisation cover type indicator may be one of ‘consultation’; ‘illness’; ‘accident’; or ‘none’ and relates to the type of cover under which the claim is authorised (if any). It should be appreciated that the authorisation cover type indicator may not match the claim cover type indicator (262) (e.g. in cases where the event is determined to be covered under another type of cover than what is claimed). Processing the event data elements to determine a set of assessment data elements may include using an algorithm (e.g. machine learning algorithm) having been trained using training data available from a reference database that is built up over time. Processing the event data elements may include using an admission matrix and/or profile information associated with the client profile identifier and retrieved from the profile database. For example, processing the event data elements may include:

Check if event not related to a previous authorisation to which the current admission could be linked.
Green Triage—Rejected illness/accident and cover under consultation.
Yellow Triage—Cover under illness/accident if procedure/overnight stay is confirmed. If not confirmed cover under vet visit.
Red Triage—Confirm authorisation of illness/accident cover.
Check that treatment plan needs to correlate with diagnosis.

For accident claim types:
Evaluate accident/injury report and radiology reports for any knee, ankle and ligament injuries.
Consider two year medical history if previous related injuries are indicated.
Injuries related to pre-existing medical conditions, for example but not limited to osteoporosis, epilepsy, or diseases causing dizziness that lead to an injury, authorise only emergency cover.

For illness claim types apply any condition specific protocols: Any procedures/conditions treated in addition to the procedure/condition authorized is subjected to assessment under the terms and conditions of the policy wording and might not be covered under the authorization given.

In some embodiments, determining authorisation may include determining and initiating a workflow. This may for example include reporting a sequence of instructions associated with the authorised claim and additional processing of data elements.

If (352) the claim is determined to be authorised, the method may include transmitting an authorisation confirmation notification. The notification may be transmitted to one or both of the remote computing device (102) and client communication device and may include the authorisation cover type indicator to indicate the type of cover under which the treatment has been authorised. Otherwise (352), the authorisation of the claim is declined (356).

The method may include updating the reference database (118), including for example storing the event data elements together with one or more of event, category and authorisation cover type indicator labels and the like.

FIG. 7 describes an embodiment of an admission matrix (400) that may be implemented in accordance with aspects of the present disclosure. The admission matrix may be any suitable data structure or rules engine describing, for example, initiating the initial processing (342) of a claim request (108), determining the category (344) and/or determining (350) authorisation and/or workflow.

Initial processing may include determining (418) the event and/or determining (420) a claim cover type indicator associated with the event.

Determining (418) the event, cover type, category, authorisation and/or workflow may include processing the relevant data indicator (258) (262) (260) from the claim request message (108) against the corresponding reference (124) (122) (120) in the reference database (118). Data indicators (258) (262) (260) may be explicitly or implicitly described by a word, string, code, collection thereof, part thereof or the like. Processing the data indicators (258) (262) (260) from the claim request message (108) against the data references (124) (122) (120) in the reference database (118) may include inputting to a classifier. The classifier may assess the indicators according to various assessment parameters. The classifier may be developed using generative or discriminative methods, such as or derived from Gaussian mixture models, K-means, logistic regression and/or the like. The data indicators (258) (262) (260) may be changed to a different set of indicators prior to processing. The different set of indicators may represent a reduction of assessment parameters, as for example with principal component analysis or the like. The classifier may be trained on collected data prior to classification. In an example embodiment, the classifier may perform maximum likelihood estimation or the like. The classifier may compare the identifier against at least a reference and report a score to determine the closeness of a “match.” In cases of multiple comparisons, the highest or lowest score may be selected. The method may further include signalling intervention if the classifier indicates an uncertainty indicator, for example if the differential between scores is below a predetermined threshold. In some embodiments, the classifier may be self-learning or self-modifying. The classifier may be implemented by the computer server (110) or another computing device accessible to the server computer.

In some embodiments, the result of processing an indicator (258) (262) (260) against at least a reference (124) (122) (120) may affect a subsequent step of processing, as illustrated in FIG. 7. The subsequent step of processing need not immediately precede processing the indicator. For example, an event (e.g. ‘a bee sting’) described in the event data elements (192) of the claim request message (108) may be determined (418) by processing the event data indicator (258), resulting, for example, in the event being identified as ‘Event A’ (452) (e.g. ‘a bee sting’) and not ‘Event B’ (454) (e.g. ‘a fracture’). If (450) ‘Event A’ is determined, cover type may be determined (420) for ‘Event A’ (452) from processing the claim cover type indicator (262), resulting, for example, in ‘Event A’ (452) being labelled for example as an ‘Accident’ (458) and not an ‘Illness’ (460) (or vice versa depending on the event determined). If (456) the cover type of Event A′ is determined to be an ‘Accident,’ the category or categories associated with ‘Illness’ (464), therefore may not be processed. The category for the ‘Accident’ cover type may be determined (344) by processing the category indicator (260). If (462) the category is determined to be ‘Yellow’ (466), for example, ‘Event A’ (452) may be labelled as a ‘Yellow Accident,’ (466) (458) and not as ‘Green’ (468) or ‘Red’ (346). The labelling of the event as a ‘Yellow Accident’ (466) (458), for example, may initiate a workflow and accompanying authorisation (472) while ignoring the other possible workflows for ‘Event A Accident Red’ (470) and ‘Event A Accident Green’ (474). It should be appreciated that the combination of indicators (258) (262) (260) may vary such that classification of the same event could result in different authorisations and workflows, depending on the indicators (258) (262) (260).

In some embodiments, the determination or assessment of account details, event, cover type, category, authorisation and/or the like, and/or the criteria or references used for the determination or assessment of account details, event, cover type, category, authorisation and/or the like, or any combination thereof as described in the preceding figures or not explicitly described, may collectively be termed ‘an admission matrix.’

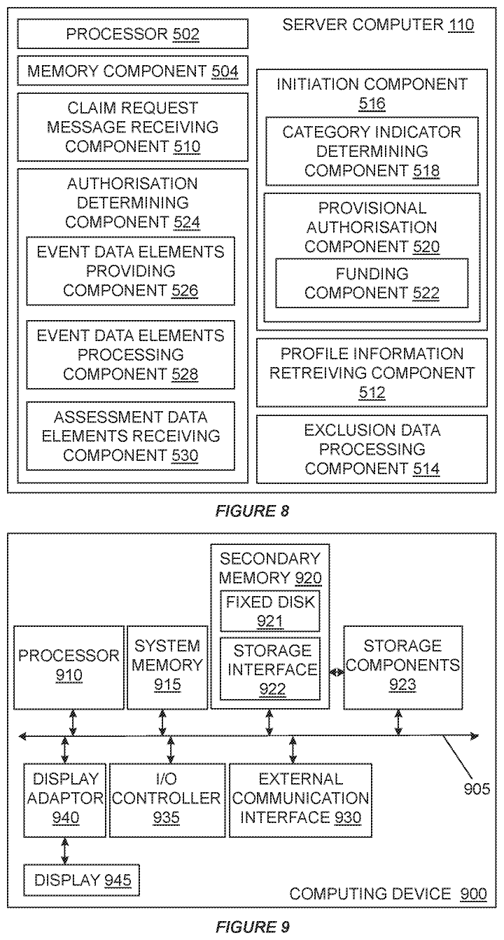

Various components may be provided for implementing the methods described above with reference to FIGS. 2 to 7. FIG. 8 is a block diagram which illustrates exemplary components which may be provided by a system for remote authorisation according to aspects of the present disclosure. The system includes a server computer (110).

The server computer (110) may include a processor (502) for executing the functions of components described below, which may be provided by hardware or by software units executing on the server computer (110). The software units may be stored in a memory component (504) and instructions may be provided to the processor (502) to carry out the functionality of the described components. In some cases, for example in a cloud computing implementation, software units arranged to manage and/or process data on behalf of the server computer (110) may be provided remotely.

The server computer (110) may include a claim request message receiving component (510) for receiving a claim request message including a client profile identifier and a set of event data elements relating to an event. The claim request message may be received from a remote computing device, such as an end-user computing device.

The server computer (110) may include a profile information retrieving component (512) arranged to retrieve profile information associated with the profile identifier. The profile information may include exclusion data and the server computer (110) may include an exclusion data processing component (514) arranged to process the event data elements against the exclusion data to determine if the claim is excluded based on the exclusion data and/or event data elements.

The server computer (110) may include an initiation component (516) arranged to initiate initial processing of a claim associated with the event. The initiation component (516) may include a category indicator determining component (518) arranged to use the event data elements to determine a category indicator with which the event is associated. The initiation component (516) may include a provisional authorisation component (520) arranged to provisionally authorise the claim and transmit an authorisation confirmation message if the event is associated with a first category indicator. The provisional authorisation component (520) may include a funding component (522) arranged to provide access to funds. The funding component may be configured to transfer funds to an account associated with a portable payment device linked to the client profile identifier.

The server computer (110) may include an authorisation determining component (524) arranged to determine authorisation of the claim. The authorisation determining component may include: an event data elements providing component (526) arranged to provide the event data elements for assessment: an event data elements processing component (528) arranged to process the event data elements to determine a set of assessment data elements relating to assessment of the event, including an authorisation cover type indicator; and, an assessment data elements receiving component (530) arranged to receive the assessment data elements and authorise the claim based on the authorisation cover type indicator. The event data elements processing component (528) may include or have access to an algorithm configured to process the event data elements to determine the assessment data elements. The algorithm may be trained on training data stored in a reference database that is built up over time using labelled event data elements.

Aspects of the present disclosure provide a system and method for remote authorisation of claims associated with events. The authorisation is based on event data elements that relate to events as well as any applicable data stored in a client profile with which the claim is associated. Aspects of the present disclosure implement a triage and admission matrix for remote authorisation and, where applicable, near real-time remote authorisation of claims. The actual cover type under which the claim is authorised depends on an evaluation of the event data elements. Thus, while a triage of claims may prioritise processing and may indicate claim cover type, the ultimate cover type under which the claim is authorised will depend on the evaluation of the event data elements. For example, Table 1 below illustrates how the event data elements of procedure and duration ultimately determine the authorisation cover type indicator indicating the type of cover under which the claim is authorised.

TABLE 1
Determination of the authorisation cover type indicator

| | | | | AUTHORISATION |
|---|---|---|---|---|
| SCENARIO | PROCEDURE | SEVERITY | DURATION | COVER TYPE |
| Scenario 1 | Minor procedure | Triage Yellow | 15 minutes | =Vet Visit |
| | (Injection) | (Treated pet | (Consultation time) | |
| | | within 5 hours) | | |
| Scenario 2 | Drip Surgery | Triage Yellow | Pet is admitted for | =Accident Cover |
| | | (Treated pet | several days with | |
| | | within 5 hours) | ongoing treatment | |
| | | | for diagnosed | |
| | | | condition (bee sting). | |
| Scenario 3 | None. | Triage Green | Pet sent home | =Vet Visit |
| | (Diagnostics not | (Kept for | with general | |
| | a procedure) | observation | medication, | |
| | | and further | inconclusive | |
| | | diagnostics) | diagnosis. | |

Tables 2 and 3 below illustrate example embodiments of an admission matrix according to aspects of the present disclosure.

TABLE 2
Illness authorisation based on a triage process

| Case | Action | | |
|---|---|---|---|
| Admission | | Forward the Vet the link for the claims forms to be | |
| within the | | completed: http://authorisation.oneplan.co.za/pet | |
| first 12 | | Review completed claim form | |
| months | | With a related exclusion or waiting period: | |
| | Decline claim and send applicable repudiation letter | | |
| | | Without a related exclusion or waiting period: | |
| | | | Green Triage—Rejected illness and cover under vet visit. |
| | | | Yellow Triage—Cover under illness if procedure/ |
| | | | overnight stay is confirmed. If not confirmed cover under |
| | | | vet visit. If in doubt, confirm with team leader/manager. |
| | | | Red triage—Authorise illness cover. |
| | | The treatment plan needs to correlate with diagnosis. | |
| | | If in doubt, request results and confirm with team | |
| | | leader/manager | |
| Admission | | Forward the Vet the link for the claims forms to be | |
| after 12 | | completed: http://authorisation.oneplan.co.za/pet | |
| months | | Once the vet submits claim form system will load as follow: | |
| | | | Green Triage—Claim forms are submitted to assessors for |
| | | | assessment. |
| | | | Yellow Triage—Claim forms are submitted to assessors |
| | | | for assessment. |
| | | | Red triage—R5000.00 deposit is loaded onto Onecard and |
| | | | claim forms are submitted to assessors for assessment. |
| | | Once claim forms are received by assessors it will be | |
| | | assessed as follow: | |
| | | | Check if not related to a previous authorisation to |
| | | | which the current admission could be linked too. |
| | | | Green Triage—Rejected illness and cover under vet visit. |
| | | | Yellow Triage—Cover under illness if procedure/ |
| | | | overnight stay is confirmed. If not confirmed cover under |
| | | | vet visit. If in doubt, confirm with team leader/manager. |
| | | | Red triage—Authorise illness cover. |
| | | | The treatment plan needs to correlate with diagnosis. |
| | | | If in doubt, request results and confirm with |
| | | | team leader/manager. |
| | | Apply condition specific protocols: | |
| | | | Any procedures/conditions treated in addition to the |
| | | | procedure/condition authorized is subjected to assessment |
| | | | under the terms and conditions of the policy wording |
| | | | and might not be covered under the authorisation given. |

TABLE 3
Accident authorisation based on a triage process

| Case | Action | |
|---|---|---|
| Admission | Forward the Vet the link for the claims forms to be | |
| within the | completed: http://authorisation.oneplan.co.za/pet | |
| first 12 | Once the vet submits claim form system will load as | |
| months | follow: | |
| | | Green Triage—Claim forms are submitted to |
| | | assessors for assessment. |
| | | Yellow Triage—Claim forms are submitted to |
| | | assessors for assessment. |
| | | Red triage—R5000.00 deposit is loaded onto Onecard |
| | | and claim forms are submitted to assessors for |
| | | assessment. |
| | Once claim forms are received by assessors it will | |
| | be assessed as follows: | |
| | | Check if not related to a previous authorisation to |
| | | which the current admission could be linked too. |
| | | Green Triage—Rejected illness and cover under vet visit. |
| | | Yellow Triage—Cover under illness if procedure/ |
| | | overnight stay is confirmed. If not confirmed cover |
| | | under vet visit. If in doubt, confirm with team leader/ |
| | | manager. |
| | | Red triage—Authorise illness cover. |
| | | The treatment plan needs to correlate with diagnosis. |
| | | If in doubt, request results and confirm with team |
| | | leader/manager. |
| | | Any knee, ankle and ligament injuries request |
| | | accident/injury report and radiology reports. |
| | | With any evidence or suspicion regarding previous |
| | | related injuries request a two year medical history. |
| | | Cover admission only when confirmed with |
| | | manager/team leader. |
| | | Injuries related to pre-existing medical conditions, |
| | | for example but not limited to osteoporosis, epilepsy, |
| | | or diseases causing dizziness that lead to an injury, |
| | | authorise only emergency cover. Cover admission |
| | | only when confirmed with manager/team leader. |
| Admission | Forward the Vet the link for the claims forms to be | |
| after 12 | completed: http://authorisation.oneplan.co.za/pet | |
| months | Once the vet submits claim form system will load as | |
| | follow: | |
| | | Green Triage—Claim forms are submitted to |
| | | assessors for assessment. |
| | | Yellow Triage—Claim forms are submitted to |
| | | assessors for assessment. |
| | | Red triage—R5000.00 deposit is loaded onto Onecard |
| | | and claim forms are submitted to assessors for |
| | | assessment. |
| | Once claim forms are received by assessors it will be | |
| | assessed as follow: | |
| | | Check if not related to a previous authorisation to |
| | | which the current admission could be linked too. |
| | | Green Triage—Rejected illness and cover under vet visit. |
| | | Yellow Triage—Cover under illness if procedure/ |
| | | overnight stay is confirmed. If not confirmed cover |
| | | under vet visit. If in doubt, confirm with team leader/ |
| | | manager. |
| | | Red triage—Authorise illness cover. |
| | | The treatment plan needs to correlate with diagnosis. |
| | | If in doubt, request results and confirm with team |
| | | leader/manager. |
| | | Any knee, ankle and ligament injuries request |
| | | accident/injury report and radiology reports. |
| | | With any evidence or suspicion regarding previous |
| | | related injuries request a two year medical history. |
| | | Cover admission only when confirmed with |
| | | manager/team leader. |
| | | Injuries related to pre-existing medical conditions, |
| | | for example but not limited to osteoporosis, epilepsy, |
| | | or diseases causing dizziness that lead to an injury. |
| | | Cover admission only when confirmed with |
| | | manager/team leader. |

FIG. 9 illustrates an example of a computing device (900) in which various aspects of the disclosure may be implemented. The computing device (900) may be embodied as any form of data processing device including a personal computing device (e.g. laptop or desktop computer), a server computer (110) (which may be self-contained, physically distributed over a number of locations), a client computer or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (900) may be suitable for storing and executing computer program code. The various participants and elements in the previously described system diagrams may use any suitable number of subsystems or components of the computing device (900) to facilitate the functions described herein. The computing device (900) may include subsystems or components interconnected via a communication infrastructure (905) (for example, a communications bus, a network, etc.). The computing device (900) may include one or more processors (910) and at least one memory component in the form of computer-readable media. The one or more processors (910) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (900) may be distributed over a number of physical locations (e.g. in a distributed, cluster or cloud-based computing configuration) and appropriate software units may be arranged to manage and/or process data on behalf of remote devices.

The memory components may include system memory (915), which may include read only memory (ROM) and random access memory (RAM). A basic input/output system (BIOS) may be stored in ROM. System software may be stored in the system memory (915) including operating system software. The memory components may also include secondary memory (920). The secondary memory (920) may include a fixed disk (921), such as a hard disk drive, and, optionally, one or more storage interfaces (922) for interfacing with storage components (923), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (900) may include an external communications interface (930) for operation of the computing device (900) in a networked environment enabling transfer of data between multiple computing devices (900) and/or the Internet. Data transferred via the external communications interface (930) may be in the form of signals, which may be electronic, electromagnetic, optical, radio, or other types of signal. The external communications interface (930) may enable communication of data between the computing device (900) and other computing devices including servers and external storage facilities. Web services may be accessible by and/or from the computing device (900) via the communications interface (930).

The external communications interface (930) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry.

The computer-readable media in the form of the various memory components may provide storage of computer-executable instructions, data structures, program modules, software units and other data. A computer program product may be provided by a computer-readable medium having stored computer-readable program code executable by the central processor (910). A computer program product may be provided by a non-transient or non-transitory computer-readable medium, or may be provided via a signal or other transient or transitory means via the communications interface (930).

Interconnection via the communication infrastructure (905) allows the one or more processors (910) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (900) either directly or via an I/O controller (935). One or more displays (945) (which may be touch-sensitive displays) may be coupled to or integrally formed with the computing device (900) via a display or video adapter (940).

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention set forth in any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A computer-implemented method for remote authorisation comprising:
receiving, from a remote computing device, a claim request message including a set of event data elements relating to an event and a client profile identifier;
initiating initial processing of a claim associated with the event including:
using the event data elements to determine a category indicator with which the event is associated; and,
if the event is associated with a first category indicator, provisionally authorising the claim and transmitting a provisional authorisation confirmation message to one or both of the remote computing device and a client communication device for initiating emergent mitigation of a condition or consequence associated with the event.

2. The method as claimed in claim 1, wherein the event data elements include data elements relating to one or more of: hospitalisation; procedure; drip setup; surgery;
sedition; anaesthesia; severity; treatment plan; duration of admittance; duration of procedure.

3. The method as claimed in claim 1, wherein provisionally authorising the claim if the event associated with the first category indicator includes providing access to funds.

4. The method as claimed in claim 3, wherein providing access to funds includes transferring funds to an account associated with a portable payment device linked to the client profile identifier.

5. The method as claimed in claim 1, wherein the event data elements include the category indicator, and using the event data elements to determine the category indicator includes extracting the category indicator from the event data elements.

6. The method as claimed in claim 1, including retrieving profile information associated with the client profile identifier, wherein the profile information includes exclusion data and the method includes:
determining if the claim is excluded based on one or both of the exclusion data and event data elements; and,
if the claim is not excluded, initiating the initial processing of the claim.

7. The method as claimed in claim 1, including determining authorisation of the claim, wherein determining authorisation of the claim includes:
providing the event data elements for assessment;
processing the event data elements to determine a set of assessment data elements relating to assessment of the event and including an authorisation cover type indicator; and,
receiving the assessment data elements and authorising the claim based on the authorisation cover type indicator.

8. The method as claimed in claim 1, including updating a reference database, including storing the event data elements together with one or more of event, category and authorisation cover type indicator labels.

9. The method as claimed in claim 8, wherein processing the event data elements to determine the set of assessment data elements includes using an algorithm having been trained using training data available from the reference database.

10. The method as claimed in claim 7, wherein processing the event data elements includes using one or both of an admission matrix and profile information associated with the client profile identifier and retrieved from a profile database.

11. A system for remote authorisation including a memory for storing computer-readable program code and a processor for executing the computer-readable program code, the system comprising:
a claim request message receiving component for receiving, from a remote computing device, a claim request message including a set of event data elements relating to an event and a client profile identifier;
an initiation component for initiating initial processing of a claim associated with the event including:
a category indicator determining component for using the event data elements to determine a category indicator with which the event is associated; and,
a provisional authorisation component for, if the event is associated with a first category indicator, provisionally authorising the claim and transmitting a provisional authorisation confirmation message to one or both of the remote computing device and a client communication device for initiating emergent mitigation of a condition or consequence associated with the event.

12. The system as claimed in claim 11, wherein the event data elements include data elements relating to one or more of: hospitalisation; procedure; drip setup; surgery; sedition; anaesthesia; severity; treatment plan; duration of admittance; duration of procedure.

13. The system as claimed in claim 11, wherein the provisional authorisation component includes a funding component for providing access to funds, and wherein the funding component is configured to transfer funds to an account associated with a portable payment device linked to the client profile identifier.

14. The system as claimed in claim 11, wherein the event data elements include the category indicator, and wherein the category indicator determining component includes a category indicator extractor component configured to extract the category indicator from the event data elements.

15. The system as claimed in claim 11, including a profile information retrieving component for retrieving profile information associated with the client profile identifier.

16. The system as claimed in claim 15, wherein the profile information includes exclusion data, and wherein the system includes an exclusion data processing component for processing the event data elements against the exclusion data to determine if the claim is excluded based on the exclusion data and/or event data elements.

17. The system as claimed in claim 11, including an authorisation determining component for determining authorisation of the claim, wherein the authorisation determining component includes:
an event data elements providing component for providing the event data elements for assessment;
an event data elements processing component for processing the event data elements to determine a set of assessment data elements relating to assessment of the event and including an authorisation cover type indicator;
an assessment data elements receiving component for receiving the assessment data elements and authorising the claim based on the authorisation cover type indicator.

18. A computer program product for remote authorisation, the computer program product comprising a computer-readable medium having stored computer-readable program code for performing the steps of:
receiving, from a remote computing device, a claim request message including a set of event data elements relating to an event and a client profile identifier;
initiating initial processing of a claim associated with the event including:
using the event data elements to determine a category indicator with which the event is associated; and,
if the event is associated with a first category indicator, provisionally authorising the claim and transmitting a provisional authorisation confirmation message to one or both of the remote computing device and a client communication device for initiating emergent mitigation of a condition or consequence associated with the event.
